(19) United States
(12) Patent Application Publication
(10) Pub. No.: US 2003/0025937 A1
(43) Pub. Date: Feb. 6, 2003

(54) Media loading in printing systems

(75) Inventors: Athena Christodoulou, Bristol (GB); Richard Taylor, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/207,068

(22) Filed: Jul. 30, 2002

(30) Foreign Application Priority Data
Jul. 31, 2001 (GB) 0118666.7

(51) Int. Cl. B41J 1/00; G06F 15/00

(52) U.S. Cl. 358/1.15

(57) ABSTRACT

A method and associated control apparatus are used to control the operation of a plurality of independent printing devices each having at least one holder. The control apparatus is arranged to store information relating to one or more print jobs scheduled to be performed by each of said plurality of printing devices. This information includes the quantity of media required to complete each of the print jobs. The control apparatus learns an initial or current quantity of media held in one or more of said printing devices and estimates or otherwise determines the quantity of media remaining in a media holder of a printing device during the performance of a print job. The control apparatus generates an alert when said quantity of media reaches a predetermined minimum value indicating that more media will be required to accommodate a particular print job.

### FIELD OF THE INVENTION

This invention relates to media monitoring and loading in printing systems and the like, and in particular to a method and apparatus for maximising the ultilisation of a plurality of printing devices operating as a system or cluster.

### BACKGROUND OF THE INVENTION

It is well known to provide a network of relatively slow printing devices connected to a single command module (as opposed to a single relatively fast printing device) in which a schedule of print jobs may be programmed for execution by the printing devices. Particularly in the case of, for example, a printing establishment, which provides printing services to a plurality of different clients, each having different requirements, such a command module is a useful way of prioritising and setting up a number of print jobs, without having to program and control each of the printers in the network individually. Variable parameters of a print job may include paper size, font type and size, content, layout, number of copies, etc., which parameters will obviously vary substantially between customers.

Modern printing devices usually have several media trays for storing and feeding different printing media (such as, different colours, sizes and types of paper) and a print job programmed into the command module would normally have specified therein the media tray of a particular printing device to be used for that job. In known systems, if a media tray runs out of the required media, a media alert is generated (either by the printing device itself and/or the command module) and the current printing operation is stopped until the media tray in question is refilled.

For example, Japanese patent application No. JP 62-186275A describes apparatus for managing/monitoring a number of copying machines by receiving and monitoring data received from each of the machines throughout the day. A display or alert is generated in the event that a machine stops copying because it has run out of paper or toner, giving an operator an opportunity to take the necessary steps to enable the machine to resume its copying job.

Under current systems, including the one described in JP 62-186275A, one or more operators are required to manually keep track of media requirements for the printers or copiers in a network in an attempt to prevent the occurrence of media alerts, because in the event of a media alert, printing stops (which wastes time and therefore reduces the efficiency of the system in itself) and restarting a stalled print engine further increases the amount of time that a printer will be off-line which is obviously undesirable. Such manual monitoring of media levels and requirements can be time-consuming and errors and oversights lead to an unnecessary number of media alerts occurring. In any event, loading or switching media in large printing jobs can take a lot of time, and is prone to human error if the operator(s) have to manually keep track of the performance of printing jobs and the media requirements for each.

U.S. Pat. No. 4,476,486 describes a control system which is intended to reduce the number of times it is required to reload the media trays of a printing device. The described system incorporates the concept of media level sensing in a printing or copying apparatus having a plurality of printing/copying units (each having its own media tray) which effectively operate as a single device. When a print job is generated, the control system can choose which (unit(s) to use according to the quantity of paper therein, the number of copies required to be produced, and the status of each of the units. A single print job could, for example, be performed by two or more of the units operating simultaneously, if necessary. However, this document does not address the issues involved in managing a network of independent printers which may be arranged in a distributed network.

We have now devised an improved arrangement which overcomes the problems and addresses the issues outlined above.

### SUMMARY OF THE INVENTION

Thus, in accordance with a first aspect of the present invention, there is provided control apparatus for use in controlling the operation of a plurality of independent printing devices, each having at least one media holder, the control apparatus comprising a storage device for storing information relating to one or more print jobs scheduled to be performed by each of said plurality of printing devices, said information including at least a quantity of media required to complete each of said print jobs, said control apparatus being arranged, in use, to receive information relating to, or otherwise determine, at least an initial or current quantity of media held in one or more of said printing devices, to estimate or otherwise determine the quantity of media remaining in a media holder of a printing device during performance of one or more print jobs, and to generate an alert when said quantity of media reaches a predetermined minimum value (greater than 0) indicating that more of said media is required to be introduced to said media holding means, to accommodate a particular print job scheduled to be performed by that printing device.

Also in accordance with a first aspect of the present invention, there is provided a method of controlling the operation of a plurality of independent printing devices each having at least one media holder, the method comprising the steps of providing control apparatus arranged to store information relating to one or more print jobs scheduled to be performed by each of said plurality of printing devices, said information including at least a quantity of media required to complete each of said print jobs, inputting information into said control apparatus relating to an initial or current quantity of media held in one or more of said printing devices, said control apparatus being further arranged to estimate or otherwise determine the quantity of media remaining in a media holder of a printing device during the performance of a print job, and to generate an alert when said quantity of media reaches a predetermined minimum value (greater than 0) indicating that more of said media is required to be introduced to said media holder accommodate a particular print job scheduled to be performed by that printing device.

In accordance with a second aspect of the present invention, there is provided a control unit for use in controlling the operation of a plurality of indepdnent printing devices, each having at least one media tray, the control apparatus comprising a memory for storing information relating to one or more print jobs scheduled to be performed by each of said plurality of printing devices, said information including at least a type of media required to complete each of said print jobs, said control unit being arranged, in use, to receive information relating to, or otherwise determine at least an initial or current type of media held in one or more of said printing devices, to determine the type of media remaining in a media tray of a printing device during the performance of one or more print jobs, and to generate an alert when said type of media is required to be changed to accommodate a particular print job scheduled to be performed by that printing device.

Also in accordance with the second aspect of the present invention, there is provided a method of controlling the operation of a plurality of independent printing devices each having at least one media tray, the method comprising the steps of providing control apparatus arranged to store information relating to one or more print jobs scheduled to be performed by each of said plurality of printing devices, said information including at least a type of media required to complete each of said print jobs, inputting information into said control apparatus relating to an initial or current type of media held in one or more of said printing devices, said control apparatus being further arranged to determine the type of media remaining in a media tray of a printing device during the performance of a print job, and to generate an alert when said type of media is required to be changed to accommodate a particular print job scheduled to be performed by that printing device.

Thus, the present invention assists a system operator in advance planning of media loading for a given set of print jobs. As a result, the operator of a large printing system defined by a distributed network of independent printers, is able to distribute print jobs and plan media loading in such a way that delays caused by media alerts can be eliminated, or at least minimised. In fact, the present invention can be arranged to propose an optimum loading strategy by informing an operator what printer should be loaded, when and with what amount and type of media.

Accordingly, a third aspect of the present invention provides control apparatus for use in controlling the operation of a plurality of independent printers, each comprising one or more media trays for holding media of varying quantities and types to accommodate different print jobs, the control apparatus comprising a memory for storing data relating to a plurality of print jobs required to be performed by said printers, said data including at least a quantity or type of media required to complete each of said print jobs, the control apparatus further comprising a processor arranged to estimate the time each of said plurality of print jobs will take to be performed, and to calculate and provide a suitable media loading strategy for use by an operator.

In accordance with a fourth aspect of the present invention, there is provided a control system for monitoring and controlling the operation of a plurality of recording units arranged in a distributed network, each of said recording units having at least one media tray, the control system comprising apparatus for monitoring the quantity or type of media in a media tray of a recording unit during the performance of one or more recording operations and generating an instruction to an operator when said quantity of media reaches a predetermined minimum value or said type of media is required to be changed, said instruction indicating an operation required to be performed by said operator, the control system further comprising apparatus for monitoring the status of said media tray to determine if said instruction has been performed and for generating a signal if said instruction is determined not to have been performed within a predetermined period of time after it has been generated.

Thus, the control unit is preferably arranged to estimate the time it takes (or should take) for a particular quantity and/or type of media to be loaded to a particular printing device. The control unit may also be arranged to generate another alert if a specified instruction has not been carried out within a predetermined period of time, which may be established by monitoring the opening and/or closing of the respective media holding means, for example. It may additionally, or alternatively, be arranged to suspend a current print job for that media holding means and send another print job to the respective printer which requires media held in another one of its media holding means, so as to prevent the printing device from stalling due to a media alert.

The control unit may be arranged to estimate the time each of a plurality of scheduled print jobs will take to be performed and subsequently the optimum time scales for loading and changing media, and to provide a schedule for use by an operator accordingly.

### BRIEF DESCRIPTION OF THE DRAWINGS

An embodiment of the present invention will now be described by way of example only and with reference to the accompanying drawings in which:

FIG. 1 is a schematic flow diagram illustrating the operation of an exemplary embodiment of the present invention; and

FIG. 2 is a schematic block diagram of a distributed printing network and a control system according to an exemplary embodiment of the present invention..

### DETAILED DESCRIPTION OF THE INVENTION

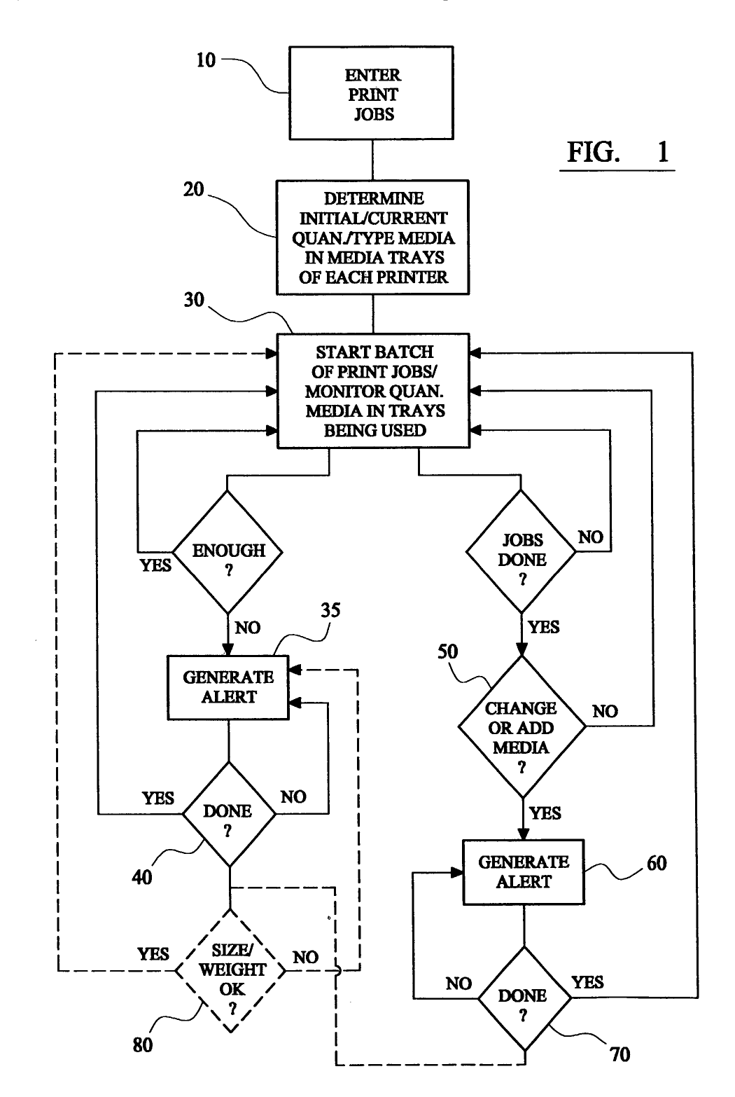

Referring to FIG. 1 of the drawings, a number of print jobs scheduled to be carried out are entered (at 10) into a control unit which controls the operation of a number of printing devices connected thereto. Such entry may of course be done manually or downloaded from a data storage area. In any event, for each of the print jobs, information relating to the quantity and type of media required to complete the respective print job is entered, together with other details including content, format, font type, font size, etc.

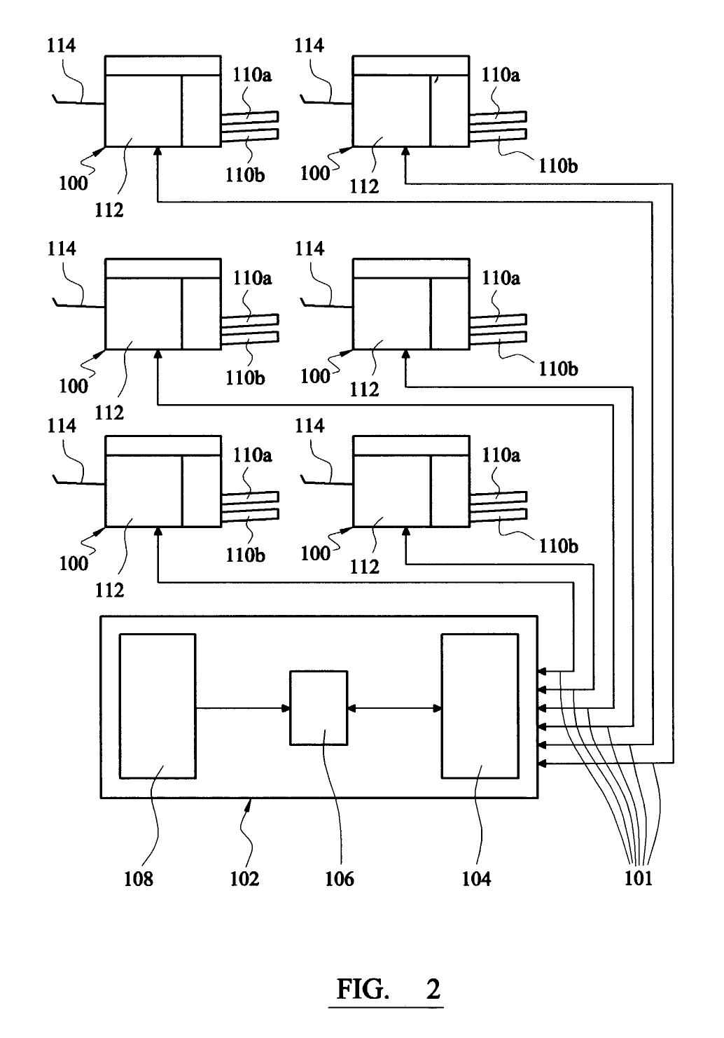

Thus, referring to FIG. 2 of the drawings, a plurality of printers 100 are connected (either by means of a hard wired or wireless communication path 101) to a control unit 102, to create a distributed printer network. It will be appreciated that the control unit 102 is illustrated in FIG. 2 in simplified form as comprising an interface 104 for transmitting data to and receiving data from each of the printers 100, a processor 106 for determining the distribution of print jobs amongst the printers 100 and generating instructions for performance by an operator, and a memory device 108 for storing details of the print jobs scheduled to be carried out by the printers 100. The control unit 102 will also have some form of display panel or screen (not shown) for displaying alerts and instructions to an operator.

Each of the printers 100 comprises at least two media trays 110a, 110b conveniently accessible externally of the main printer body 112. Copies printed by each of the printers 100 are discharged to a respective output tray 114.

Each printer 100 is provided with an arrangement (not shown) for monitoring the quantity of paper in the trays 110a, 110b. Such an arrangement maybe relatively simple and comprise an electromagnetic radiation transmitter and corresponding receiver on opposite inner side walls of each tray 110a, 110b, such that when the height of a stack of paper is above a predetermined level (i.e. the height of the transmitter/receiver arrangement), the electromagnetic radiation transmitted by the transmitter is prevented from reaching the receiver on the opposite side wall by the stack of paper therebetween. However, once the height of the stack of paper falls below the predetermined level, the electromagnetic radiation from the transmitter has a clear path to the receiver, and the receiver may be arranged to generate a signal when it receives the electromagnetic radiation to indicate that the level of media in the respective tray has fallen below a predetermined minimum value.

However, the arrangement described above is not particularly accurate, and it is more desirable to provide a more accurate system for monitoring the level of paper in the trays 110a, 110b. For example, in U.S. Pat. No. 5,079,722, potentiometers are provided for the media trays 110a, 110b to measure the heights of the stacks of paper therein. Each potentiometer changes its resistance with the change in position of an actuator which is set in contact with the top of a stack of paper, and outputs an electrical signal, such as a voltage or current signal, representing the change in resistance. The output detection signals from each of the potentiometers maybe supplied to the processor 106 via the interface 104 of the control unit 102 to indicate the amount of paper remaining in each of the trays 110a, 110b.

Referring back to FIG. 1 of the drawings, in an alternative embodiment, the control unit may already have details of the quantity and type of media remaining in the media trays of each of the printing devices (from the previous day's activities, say), but otherwise, the operator may load up the trays with an initial batch of the required media for the first set of jobs and inform the control unit accordingly (at 20).

The first set of print jobs are then started and, as they are performed, the control unit monitors their progress relative to the initial quantity and type of media in the respective media trays. If the control unit determines (at 30) that the quantity of media in a media tray being used for a print job is running low (i.e. less than a predetermined number of units remaining) and is less than that required to complete the current print job, it generates an alert (at 35) and a message appears on a display screen informing the operator that more media is required to be loaded into the media tray in question to complete the print job. The control unit may include means for determining whether a predetermined media tray has been opened and closed (thereby indicating that it has been reloaded) and, in the event that this does not occur within a predetermined period of time, it may be arranged to generate another alert to the operator (at 40).

In the event that a particular print job associated with a particular media tray is completed, the control unit (at 50) analyses the next print job scheduled to be performed from that media tray. In the event that the type of media is required to be changed, an alert is generated (prior to starting the next print job) alerting the operator of this fact (at 60). Again, if the required action has not been carried out within a predetermined period of time (as determined by the opening of the relevant media tray, as before, a reminder alert signal may be generated) (at 70).

The control unit may also be arranged to determine or receive data from the printers 100 relating to the size and/or weight of media alerted in a particular media tray in order to verify that the media loaded therein is (probably) the correct one (or otherwise) for a particular print job, and if not, it may be arranged to generate an alert accordingly (at 80).

In summary, the present invention provides a way of determining in advance when and where a media alert will occur by knowing the initial amount of media loaded on each of the printers within a cluster, and calculating the media types and requirements for pending print jobs. Given an assignment of the pending jobs to printers in the cluster, the control unit can estimate when each of the printers in the cluster will run out of a specific type of media, and propose the optimum media loading strategy by informing the operator(s) what printer must be loaded, when and with what amount and type of media. This can be done because the invention can keep track of the requirements of pending jobs, knows the current state of the printers, and can estimate how much time it takes to load a specific amount of media to a printer. Finally, the invention can monitor and get feedback from the current system state and if the operator fails to perform the expected loading within a predetermined period of time, as a result of which the invention may be arranged to suspend the job currently being performed, and may attempt to send to the relevant printer another job from those pending which requires a different type of media (contained in a different media tray of the same printer) to avoid the printer being stalled.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Control apparatus for use in controlling the operation of a plurality of independent printing devices, each having at least one media holder, the control apparatus comprising a storage device for storing information relating to one or more print jobs scheduled to be performed by each of said plurality of printing devices, said information including at least a quantity of media required to complete each of said print jobs, said control apparatus being arranged, in use, to receive information relating to, or otherwise determine, at least an initial or current quantity of media held in one or more of said printing devices, to estimate or otherwise determine the quantity of media remaining in a media holder of a printing device during performance of one or more print jobs, and to generate an alert when said quantity of media reaches a predetermined minimum value (greater than 0) indicating that more of said media is required to be introduced to said media holding means, to accommodate a particular print job scheduled to be performed by that printing device.

2. Control apparatus according to claim 1, arranged to estimate the time it takes (or should take) for a particular quantity of media to be loaded to a particular printing device.

3. Control apparatus according to claim 1, wherein said alert comprises or includes an instruction to an operator.

4. Control apparatus according to claim 3, arranged to generate a second alert if an instruction has not been carried out within a predetermined period of time.

5. Control apparatus according to claim 3, wherein the fact that an instruction has not been carried out within a predetermined period of time is established by the apparatus by monitoring the opening and/or closing of the respective media holder.

6. Control apparatus according to claim 4, arranged to suspend a current print job if the media holder being used for that print job has not been reloaded within said predetermined period of time.

7. Control apparatus according to claim 6, wherein when a current print job is suspended, another print job is initiated on the same printing device using a different media holder.

8. Control apparatus according to claim 1, wherein the control apparatus is arranged to estimate the time each of a plurality of scheduled print jobs will take to be performed, and calculate and provide a suitable media loading strategy for use by an operator.

9. A control unit for use in controlling the operation of a plurality of independent printing devices, each having at least one media tray, the control apparatus comprising a memory for storing information relating to one or more print jobs scheduled to be performed by each of said plurality of printing devices, said information including at least a type of media required to complete each of said print jobs, said control unit being arranged, in use, to receive information relating to, or otherwise determine at least an initial or current type of media held in one or more of said printing devices, to determine the type of media remaining in a media tray of a printing device during the performance of one or more print jobs, and to generate an alert when said type of media is required to be changed to accommodate a particular print job scheduled to be performed by that printing device.

10. A control unit according to claim 9, arranged to estimate the time it takes (or should take) for a particular type of media to be loaded to a particular printing device.

11. A control unit according to claim 9, wherein said alert comprises or includes an instruction to an operator.

12. A control unit according to claim 11, arranged to generate a second alert if a specified instruction has not been carried out within a predetermined period of time.

13. A control unit according to claim 12, wherein the fact that a specified instruction has not been carried out within a predetermined period of time is established by the apparatus by monitoring the opening and/or closing of the respective media tray.

14. A control unit according to claim 12, arranged to suspend a current print job if the media tray being used for that print job has not been reloaded within said predetermined period of time.

15. A control unit according to claim 14, wherein when a current print job is suspended, another print job is initiated on the same printing device using a different media tray.

16. A control unit according to claim 9, wherein the control unit is arranged to estimate the time each of a plurality of scheduled print jobs will take to be performed, and calculate and provide a suitable media changing strategy for use by an operator.

17. A method of controlling the operation of a plurality of independent printing devices each having at least one holder, the method comprising the steps of providing control apparatus arranged to store information relating to one or more print jobs scheduled to be performed by each of said plurality of printing devices, said information including at least a quantity of media required to complete each of said print jobs, inputting information into said control apparatus relating to an initial or current quantity of media held in one or more of said printing devices, said control apparatus being further arranged to estimate or otherwise determine the quantity of media remaining in a media holder of a printing device during the performance of a print job, and to generate an alert when said quantity of media reaches a predetermined minimum value (greater than 0) indicating that more of said media is required to be introduced to said media holder to accommodate a particular print job scheduled to be performed by that printing device.

18. A method of controlling the operation of a plurality of printing devices according to claim 17, the method including the step of estimating the time it takes (or should take) for a particular quantity and/or type of media to be loaded to a particular printing device.

19. A method of controlling the operation of a plurality of printing devices according to claim 17, wherein said alert comprises or includes an instruction to an operator.

20. A method according to claim 19, including the step of generating a second alert if an instruction has not been carried out within a predetermined period of time.

21. A method according to claim 20, including the step of suspending a current print job for a particular media holder in the event that an instruction has not been carried out within a predetermined period of time, and sending another print job to the same printer using a different media holder.

22. A method of controlling the operation of a plurality of independent printing devices each having at least one media tray, the method comprising the steps of providing control apparatus arranged to store information relating to one or more print jobs scheduled to be performed by each of said plurality of printing devices, said information including at least a type of media required to complete each of said print jobs, inputting information into said control apparatus relating to an initial or current type of media held in one or more of said printing devices, said control apparatus being further arranged to determine the type of media remaining in a media tray of a printing device during the performance of a print job, and to generate an alert when said type of media is required to be changed to accommodate a particular print job scheduled to be performed by that printing device.

23. A method of controlling the operation of a plurality of printing devices according to claim 22, the method including the step of estimating the time it takes (or should take) for a particular type of media to be loaded to a particular printing device.

24. A method of controlling the operation of a plurality of printing devices according to claim 22, wherein said alert comprises or includes an instruction to an operator.

25. A method according to claim 24, including the step of generating a second alert if an instruction has not been carried out within a predetermined period of time.

26. A method according to claim 25, including the step of suspending a current print job for a particular media tray in the event that an instruction has not been carried out within a predetermined period of time, and sending another print job to the same printer using a different media tray.

27. A control system for monitoring and controlling the operation of a plurality of recording units arranged in a distributed network, each of said recording units having at least one media tray, the control system comprising apparatus for monitoring the quantity or type of media in a media tray of a recording unit during the performance of one or more recording operations and generating an instruction to an operator when said quantity of media reaches a predetermined minimum value or said type of media is required to be changed, said instruction indicating an operation required to be performed by said operator, the control system further comprising apparatus for monitoring the status of said media tray to determine if said instruction has been performed and for generating a signal if said instruction is determined not to have been performed within a predetermined period of time after it has been generated.

28. A control system according to claim 27, wherein said signal triggers an alert indicating that said instruction has not been performed within said predetermined period of time.

29. A control system according to claim 27, wherein said recording unit comprises at least two media trays, and said signal causes a current recording operation on said recording unit to be suspended and another recording operation to be initiated on the same recording unit using a different media tray.

30. Control apparatus for use in controlling the operation of a plurality of independent printers, each comprising one or more media trays for holding media of varying quantities and types to accommodate different print jobs, the control apparatus comprising a memory for storing data relating to a plurality of print jobs required to be performed by said printers, said data including at least a quantity or type of media required to complete each of said print jobs, the control apparatus further comprising a processor arranged to estimate the time each of said plurality of print jobs will take to be performed, and to calculate and provide a suitable media loading strategy for use by an operator.
